(19) United States
(12) Patent Application Publication
(10) Pub. No.: US 2004/0015500 A1
(43) Pub. Date: Jan. 22, 2004

(54) Selection rate based rearranging of menu items in an electronic device

(76) Inventor: Pierluigi Pugliese, Vaterstetten (DE)

Correspondence Address: Docket Administrator, Agere Systems Inc., Room 4U-533C, 4 Connell Drive, Berkeley Heights, NJ, 07922-2747, US

(21) Appl. No.: 10/618,118

(22) Filed: Jul. 11, 2003

(30) Foreign Application Priority Data
Jul. 19, 2002 (DE) 102 32 906.0

(51) Int. Cl. G06F 17/30

(52) U.S. Cl. 707/9

(57) ABSTRACT

The invention relates to the accessibility of a predetermined number of menu items prearranged within a menu structure implemented in an electronic device. An object of the invention is to provide a new and improved approach of easy accessibility to intended menu items, in particular providing a dynamic reorganization of the operating menu structure according to the real need of a user. The invention proposes an approach of providing selectable access to a predetermined number of menu items prearranged within an operating menu structure implemented in an electronic device, especially in a user transceiver device of a mobile transmission system, wherein the menu structure is adaptable by rearranging menu items dependent on the respective selection rate of said menu items.

### CROSS-REFERENCE TO RELAT D APPLICATION

This application claims priority of German Patent Application No. 102 32 906.0, which was filed on Jul. 19, 2002.

### BACKGROUND OF THE INVENTION

The invention relates to a method of providing selectable access to a predetermined number of menu items prearranged within a menu structure implemented in an electronic device, an electronic device comprising such functionality and to an implementation software product adapted for performing such method.

As known, many electronic devices comprise an operating menu with a predefined specific menu structure according to which selectable menu items are ordered. For example a transceiver device of a transmission system, in particular a mobile station of a mobile radio system, may comprise such ordered menu items for handling messages, a phone book, an indication modus for incoming messages or calls and/or for controlling the use of the electronic device as such for example.

However, in most cases the menu items of the operating menu in the electronic device are organised according to a sequence or structure the manufacturer thinks that this sequence or structure would be logic. Unfortunately, often this predefined organisation might not seem logic to the end user.

With regard to a mobile station for example, delete operations are normally performed in a mobile station via menu operations that might involve a plurality number of key presses. This holds true, as the delete operation is intended to be used carefully and hence, is normally not placed as one of the first items in the menu structure. Consequently, a user has to scroll up and/or down the menu structure until he finds the delete function for selecting resulting in a relatively large amount of key presses. While these key presses are a useful safety measure for deleting one entry they might become very frustrating for the user if he has to delete for example the whole phone book.

Thus even if the menu structure of an operating menu implemented in an electronic device reduced or is chosen based on the consideration of the most commonly used functions, normally no menu structure matches perfectly the individual behaviour of a respective user.

An object of the invention is therefore to provide a new and improved approach of easy accessibility to intended menu items embedded within an operating menu structure avoiding problems and/or drawbacks of the known state of the art as discussed above and in particular providing a dynamic reorganisation of the operating menu structure according to the real need of a user.

Accordingly, the invention proposes an adaptability of the menu structure by rearranging menu items in dependence of the respective selection rate of said menu items.

One of the most advantages is, that the menu structure and hence, the arrangement of the menu items is directly adapted to the need of the user so that the inventive approach can significantly reduce the number of selection steps necessary to select or enter a specific menu item.

In practice, it is proposed to exchange one menu item for an other menu item in dependence on their respective selection rates and/or to change the position of a menu item in response to a frequent selection.

Furthermore, according to very preferred refinements, the invention suggests to additionally order menu items in dependence on their selection rates for further reducing the total number of selection steps for frequently selecting same menu items. Thus, such ordering results in a smart adaptation of the menu structure based on the behaviour of the user and hence, is assisting the user in a very suitable and improved way.

Additionally, in particular in response to successive selections of a specific menu item it is proposed to rank said menu item for moving said menu item frequently used, for example, to a front position within the menu structure for further reducing the total number of selection steps needed to select said menu item in future.

In order to further enhance the usability for the user, preferably the menu structure is reorganised merely, when the electronic device is in a corresponding learning mode. Thus, by activating a learning mode prior to adapting the menu structure, in substantial any possible confusion of the user is avoided in comparison to a continuous change or adaptation of the menu structure.

As an alternative or in addition it is further proposed according to very preferred refinements of the invention, that menu items pre-arranged within a common logical area of the menu structure are merely re-organised or re-arranged within their respective logical area, forming a sub-layer or a sub-menu for example.

Moreover as a further alternative or in addition, it is proposed to activate the step of the adaptation by selecting a corresponding menu item, comprising for example a special man machine interface (MMI) command.

In particular in this regard it is further proposed that prior to such step of adaptation a calculation of a new menu structure is performed in dependence on, preferably continuously, collected data about the respective selection rates of the menu items of the current menu structure.

As a further improvement, it is proposed that prior to the step of adaptation a proposal for the adaptation of the menu structure, i.e. of the new menu structure, based on the collecting data is provided, so that the user can confirm or even deny the proposed new menu structure.

Furthermore, especially in this regard the inventive approach is additionally proposing, that a threshold representing a degree of distinction between a new menu structure and the respective current menu structure is defined, so that the step of providing a proposal for the adaptation and/or for the re-arrangement of menu items is performed in dependence on whether said threshold is reached or not.

In this regard it is further proposed, to monitor the pre-set or definable threshold by counting one for every menu item in a new structure that has no corresponding match in the current menu structure.

Especially for performing the above inventive method a correspondingly adapted electronic device comprising such functionality, in particular by the incorporation of means for indicating menu items which can be selected from an operating menu structure implemented in said electronic device, means for adapting the menu structure by re-arranging menu items in dependence on the respective selection rate of said menu items, preferably is provided with a counter and means for respectively incrementing a counter value assigned to a menu item in response to a selection of said menu item.

Moreover, the inventively adapted electronic device is preferably further provided with means for assigning to each selected menu item a respective reference value representing the amount of selections of a said menu items and/or means for updating said reference value each time the associated menu item is selected, in particular by setting the reference value equal to the corresponding counter value.

In particular for rearranging menu items in an efficient way the inventive electronic device is further comprising means for comparing a current menu structure with a calculated new menu structure prior to adapt the current menu structure accordingly. Moreover, in this regard it is further proposed to provide means for monitoring a defined or definable threshold representing a degree of distinction between a new menu structure and the respective current menu structure and means for providing a proposal for a new menu structure and/or for providing the rearrangement of menu items in case the threshold is passed.

Moreover, the electronic device preferably comprises a micro processor in particular a programmable micro processor and at least one storage associated therewith.

Based thereon a correspondingly designed implementation software product adapted for performing the inventive method can be easily implemented in said electronic device for providing a further improved flexibility of the inventive approach.

Moreover, a very preferred but exemplar embodiment of the electronic devices is intended as being a mobile station for a mobile radio system, wherein said system preferably is a GSM (Global System for Mobile Communication) and or a UMTS (Universal Mobile Telecommunication System) based system, preferably operating on a division multiple access-standard and/or on a packet switching standard. A further embodiment of the inventive electronic devices is for instance, a PDA (Personal Digital Assistant).

In addition to further improve the easy accessibility to the selectable menu items, it is proposed that the operating menu comprises a graphical means for depicting the menu structure and/or menu items and hence, the selection of such menu items may be performed by controlling the graphical means.

Furthermore, the operating menu may be controlled by means of a key board or key pad having press keys or press buttons, preferably with at least some of which may be respectively assigned to certain specific items of the menu structure. The operating menu may be even controlled by a touch sensitive display for directly manipulate displayed menu items or may be additionally or as an alternative speech operated.

### BRIEF DESCRIPTION OF THE DRAWINGS

Subsequently, the invention is exemplary described based on preferred embodiments and with regard to the accompanied drawings, in which:

FIG. 1 is schematically showing a preferred basic structure of a menu structure implemented within an electronic device according to the invention, and

FIG. 2 is showing a schematic flow sheet representing preferred approaches according to the invention for providing an user dependent optimised accessibility to a number of menu items pre-arranged within the operating menu structure according to FIG. 1

### DETAILED DESCRIPTION

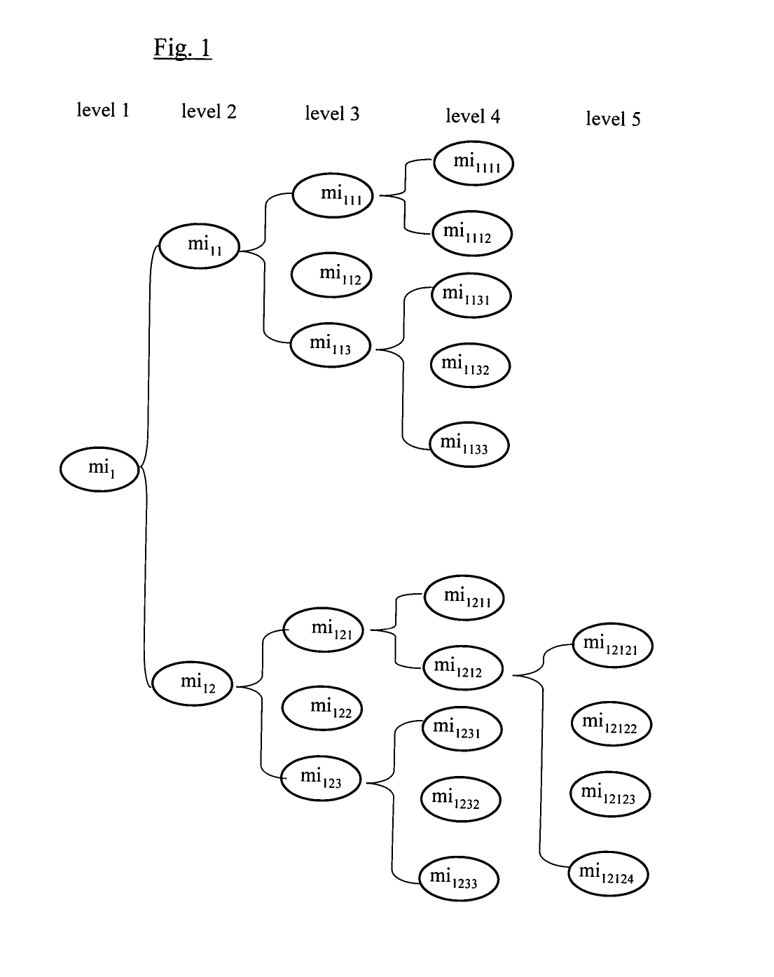

Referring next to FIG. 1, the basic principle of a preferred but exemplar menu structure implemented in an electronic device, such as a mobile phone of a mobile radio system is schematically depicted. Moreover, the mobile radio system and hence, the preferred mobile phone associated thereto is based on a GSM-standard and/or UMTS-standard and is preferably operating on a division multiple access-standard and/or the packet switched standard, such as GPRS.

As can be seen from FIG. 1, the menu structure is hierarchically pre-organised in different layers or levels, such as logical areas and/or sub-menus for example.

By selecting the menu item mil of the most upper layer, indicated as level 1, two further menu items mi₁₁₁ and mi₁₁₂ can be separately selected out of the subsequent lower layer, indicated as level 2. Based thereon, by further selecting the first of these two menu items, i.e. the menu item mill three subsequently arranged menu items on a third level, i.e. mi₁₁₁, mi₁₁₂ and mi₁₁₃ of level 3, can be individually selected. By further selecting the menu item mi₁₁₁, in turn two subsequently arranged menu items mi₁₁₁₁, and mi₁₁₁₂ on level 4 and by selecting the menu item mi₁₁₃ three subsequently arranged menu items mi₁₁₃₁, mi₁₁₃₂ and mi₁₁₃₃ on level 4 can be individually selected.

Based on the afore-mentioned mobile phone being the electronic device, the selection usually is performed by pressing a corresponding key on a keyboard incorporated within the electronic device. If several items are arranged within one logical area and/or sub-menu, such as for example mi₁₁₁, mi₁₁₂ and mi₁₁₃ in level 2, one of these has to be pre-selected for example by scrolling up and/or down with a further corresponding key of the keyboard.

It is mentioned however, that in dependence on the specific refinements of the respective electronic device, the selection of menu items may be also performed by speech control and/or by using a touch screen monitor, as for example provided by most PDAs (Personal Digital Assistant).

Each of the menu items mix, wherein the index x represents for example the predefined ordering according to FIG. 1, usually is assigned to an associated operating function.

Based on the preferred application of a mobile phone, such operating functions may comprise functions to handle messages, for example to edit and/or to create messages such as voice- or text-messages, to control the settings for such messages or any associated mail box, to handle the ringer and/or the phone book, to select, to delete or to add any entry thereof, to match the control settings, the time, charges and/or language et cetera.

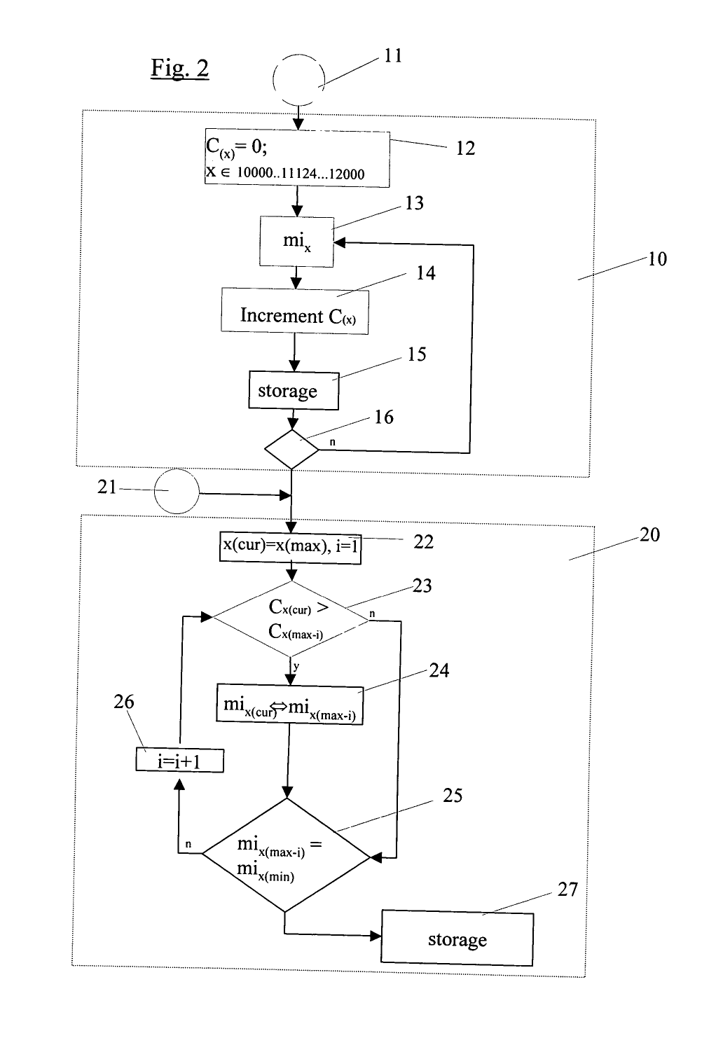

Referring next to FIG. 2 in detail, a flow chart indicating preferred embodiments of the inventive approach is schematically depicted for providing an easy accessibility for the user of the mobile phone having a pre-defined menu structure according to FIG. 1.

According to FIG. 2 and since a constant change in the menu structure might confuse the user, it is proposed to activate 11 or 21 the inventive approach wilfully by the user prior to start the reorganisation procedure 20.

This activation may involve the activation 11 of a “learning mode” 10, i.e. the user switches on this mode whenever he wants. In this case the menu structure might change after the data collecting mode 10 or learning mode. It is noted, that even embodiments are comprised by the inventive approach, wherein the menu structure is changed after each access to the menu structure.

On the other hand side, a collection of data, as indicated by reference sign 10, about the menu accesses may also be collected always, but the reorganisation 20 of the menu structure itself is performed only when the user activates 21 said reorganisation, by using for example a special MMI comment.

In principle, the activation 11 and/or 21 of the inventive approach may be performed by pressing a corresponding key of the keyboard or by speech control of for example by use of a touch screen display.

Regarding the collection mode 10 in more detail, at the beginning of the collection 10 of menu accesses a respective counter C₍ₓ₎ for each menu item mix is set to 0, wherein the index x, as mentioned above, represents a specific ordering of the menu item within the menu structure. Regarding the menu structure of FIG. 1, for representing the menu item mil of level 1 the index x of FIG. 2 is incorporating for example the number 10000, for representing the menu item mi₁₁₃₂ of level 4 the index x is incorporating the number 11320 and for representing the menu item mi₁₂ of level 2 the index x is incorporating the number 12000. Hence, the respective level in which the menu item is prearranged and the respective hierarchical order within said level is represented by the index x.

Each time the user selects a specific menu item mix from a given number of menu items, for example by means of subsequently pressing a plurality of keys of the keyboard, as indicated by referenced sign 13, the associated counter C₍ₓ₎ is incremented by one, as indicated by reference sign 14. Then the respective associated counter value C₍ₓ₎ is stored in an storage means 15.

If the learning mode 10 according to FIG. 1 is not or should not be finished, the next menu item mix can be selected, i.e. accessed, as indicated by reference sign 13. For the decision if the data collecting procedure 10 has to be continued or not, as indicated by reference sign 16, practically an interactive menu part may be provided by the mobile phone for the user.

As mentioned above such a data collecting procedure 10 may run all the time, preferably in the background, or may be activated any time the user wants. A procedure 20 for the real re-organisation of the menu structure or the menu item however, is practically performed merely in response to a wilful activation 10b of the user, for example by use of a special MMI comment, to not result in a confusion.

Regarding next a preferred but exemplar re-organisation of the menu structure, the principle concept thereof is schematically depicted and referenced by reference sign 20.

In case the re-organisation 20 is performed subsequent to the end of the collection 10 of the selection rates of respective menu items miₓ or after a separate activation 21 of the re-organisation 20, the current index x, i.e. x(cur) is set to the maximal index x, i.e. to x(max). Regarding FIG. 1, this maximal x(max) would be “12124” for the menu item arranged in the lowest level 5 at the lowest order. Additionally, an index i is set to 1.

Subsequent thereto, it is checked, as indicated with reference sign 23, if the respective counter value C_{x(cur)} assigned to the current menu item mi_{x(cur)} is greater than the counter value Cₓ₍ₘₐₓ₋ᵢ₎ associated to the menu item miₓ₍ₘₐₓ₋ᵢ₎. Based on the aforementioned assumption, that the index i is set to 1, the index “x(max−i)” is indicating the menu item arranged one rank before the current menu item mi₁₂₁₂₄. Thus with regard to FIG. 1, the menu item miₓ₍ₘₐₓ₋ᵢ₎ is m₁₁₂₁₂₃ and hence, the index “x(max−i)” is “12123”.

If the result of the examination 23, whether the respective counter value C_{x(cur)} assigned to the current menu item mi_{x(cur)} is greater than the counter value Cₓ₍ₘₐₓ₋ᵢ₎ associated to the menu item miₓ₍ₘₐₓ₋ᵢ₎, is true, than the menu item mi_{x(cur)} is replaced with the menu item miₓ₍ₘₐₓ₋ᵢ₎, as indicated by reference sign 24.

Within the next step 25 of the re-organisation procedure 20, it is checked if the menu item miₓ₍ₘₐₓ₋ᵢ₎ is equal to the menu item miₓ₍ₘᵢₙ₎, i.e. the menu item in the most upper level and at the most upper rank thereof. With regard to FIG. 1 this would be the menu item mix.

If the result of the examination 23 however, is not true than step 25 of the reorganisation procedure 20 is directly performed.

If the result of the examination step 25 is not true, i.e. menu item miₓ₍ₘₐₓ₋ᵢ₎ is not equal to the menu item miₓ₍ₘᵢₙ₎, “i” is incremented by one, as indicated by reference sign 26, and the next counter values are compared with each other according to reference sign 23. This means, that it is examined in turn, whether the respective counter value C_{x(cur)} assigned to the current menu item mi_{x(cur)} is greater than the counter value Cₓ₍ₘₐₓ₋ᵢ₎ associated to the menu item miₓ₍ₘₐₓ₋ᵢ₎.

If the most upper menu item however is reached as a result of the examination step 25, the achieved, re-organised menu structure is stored in a storage 27.

Depending on the specific embodiment of the mobile phone and/or the processor unit incorporated therein and/or the implemented software for carrying out the inventive frequency-based rearranging of menu items, the stored new reorganised menu structure may be directly implemented within the phone or said calculated new menu structure may be proposed to the user for implementation prior to implement the new menu structure. In the latter case, the user practically may confirm the implementation or not.

Additionally or as a further alternative, the new calculated menu structure stored in storage 27 of FIG. 2 is proposed to the user only if the new calculated menu structure differs from the current structure by a certain amount. For calculating this amount or distance, a threshold, which may be pre-implemented or selectable by the user, may be monitored for example simply by counting one for every menu item in the new structure that has no corresponding match in the current structure.

This would be the case for example, if the menu item mi₁₂₁₁ and the menu item mi₁₂₁₂₂ of the current menu structure according to FIG. 1 would be replaced by each other in the new calculated menu structure.

As a further alternative or in addition, the reorganisation of the menu structure may be restricted within the logical areas of the menu items themselves. For example, the menu items 11xxx of the level 4 are merely reordered within said level 4. Moreover, the reorganisation can be further restricted in that only the menu items which are together in one sub-menu of a specific menu item of an upper level may be rearranged among themselves. For example the menu items mi₁₁₃₁, mi₁₁₃₂ and mi₁₁₃₃ forming a sub-menu of menu item mi₁₁₃ may be changed among themselves and/or the menu items mi₁₁₁₁ and mi₁₁₁₂ comprised by the submenu of menu item mi₁₁₁ may be changed among themselves.

As a further alternative, if a menu item within a sub-menu is frequently accessed as much as the associated menu item of the respective upper level, then the menu item of the sub-menu may be rearranged within the upper level by its own. For instance, if the menu item mi₁₂₃ of level 3 is only accessed to select out of the subsequent submenu of level 4 the menu item mi₁₂₃₂, then the menu item mi₁₂₃₂ may be ranked on level 3, for example being a new ordered menu item mi₁₂₄. However, the order of a such new structured level 3 may be reordered, too.

Thus the inventive approach comprises a plurality of specific embodiments, in particular dependent on the individual need of the respective user and of course on the specific hard- and/or software within the specific electronic device having a pre-given menu structure of an operating menu.

Thus the inventive approach reduces greatly the number of selection steps, i.e. in particular key presses, needed to enter a menu item and adapts automatically a pre-given menu structure to the need of the user.

What is claimed:

1. A method of providing selectable access to a predetermined number of menu items prearranged within an operating menu structure implemented in an electronic device comprising,
adapting the menu structure by rearranging menu items dependent on the respective selection rate of said menu items.

2. A method of claim 1, wherein the step of adapting comprises the step of moving a menu item in response to the respective selection rate.

3. A method of claim 1, wherein the step of adapting comprises the step of ordering selected menu items dependent on their selection rates.

4. A method of claim 1 wherein a learning mode is activated by selecting a corresponding menu item prior to adapting the menu structure.

5. A method of claim 1 wherein the menu items are prearranged within logical areas and the step of adapting the menu structure is performed by rearranging the menu items within their respective logical areas.

6. A method of claim 1, further comprising the step of calculating a new menu structure dependent on collected data about the respective selection rates of the menu items within the current menu structure prior to the step of adapting.

7. A method of claim 1, further comprising the step of collecting data about respective selection rates and the step of providing a proposal for the adaptation prior to the step of adapting.

8. A method of claim 1, further comprising the step of defining a threshold representing a degree of distinction between a new menu structure and the respective current menu structure and in response to the reaching of the threshold the step of providing a proposal for a new menu structure.

9. A method of claim 8, wherein the reaching of the threshold is monitored by counting one for every menu item in a new structure that has no corresponding match in the current menu structure.

10. An electronic device, comprising means for indicating menu items which can be selected from an operating menu structure implemented in said electronic device, and
means for adapting the menu structure by rearranging menu items dependent on the respective selection rate of said menu items.

11. An electronic device of claim 10, comprising a counter and means for respectively incrementing the counter value assigned to a menu item in response to a selection of said menu item.

12. An electronic device of claim 10, comprising means for assigning to each selected menu item a respective reference value representing the amount of selections of said menu item and means for updating said reference value each time the associated menu item is selected.

13. An electronic device of claim 10, comprising means for comparing a current menu structure with a calculated new menu item, a programmable microprocessor, and at least one storage associated therewith.

14. An electronic device of claim 10, comprising means for activating the adaptation of the menu structure and means for activating a learning mode prior to activate the adaptation.

15. An electronic device of claim 10, comprising an implemented menu structure divided into logical areas.

16. An electronic device of claim 10, comprising means for calculating a new menu structure dependent on collected data about the respective selection rates.

17. An electronic device of claims 10, comprising means for collecting data about respective selection rates and means for providing a proposal for the adaptation of the menu structure.

18. An electronic device of claim 10, comprising means for monitoring a predefined or definable threshold representing a degree of distinction between a new menu structure and the respective current menu structure.

19. An electronic device of claim 18, wherein the means for monitoring the threshold is designed to count one for every menu item in a new structure that has no corresponding match in the current menu structure.

20. An electronic device of claim 10, comprising means for graphically depicting the menu structure and menu items arranged within said menu structure and means for selecting the menu items, by controlling the means for graphically depicting.

21. An electronic device of claim 10, having control means comprising a key board with at least some keys respectively assigned to specific menu items, wherein the control means comprises a touch sensitive display or is speech-operated.
